(19) United States
(12) Patent Application Publication
(10) Pub. No.: US 2024/0289019 A1
(43) Pub. Date: Aug. 29, 2024

(54) TECHNIQUES FOR EFFICIENT MEMORY SYSTEM PROGRAMMING

(71) Applicant: Micron Technology, Inc., Boise, ID (US)

(72) Inventors: Luca Porzio, Casalnuovo (NA) (IT); Daniela Ruggeri, Torre del Greco (NA) (IT); Dionisio Minopoli, Frattamaggiore (NA) (IT); Paolo Amato, Treviglio (BG) (IT)

(21) Appl. No.: 18/444,977

(22) Filed: Feb. 19, 2024

Related U.S. Application Data
(60) Provisional application No. 63/447,852, filed on Feb. 23, 2023.

(51) Int. Cl. G06F 3/06

(52) U.S. Cl. CPC G06F 3/0611; G06F 3/0659; G06F 3/0679

(57) ABSTRACT

Methods, systems, and devices for techniques for efficient memory system programming are described. A memory system may operate in a programming mode to be programmed with data at various stages of being implemented into a system. In some examples, the memory system may write data according to a programming command sequence, including a first command indicating multiple logical block address (LBA) ranges of the memory system. The memory system may receive multiple second commands that each include data associated with respective LBA ranges and may write, for each respective LBA range, data to physical addresses of the memory system. Alternatively, the memory system may write a value to a register indicating a total quantity of LBAs associated with writing data while operating in the programming mode. The memory system may decrement the value of the register in response to writing data to the memory system.

### CROSS REFERENCE

The present application for patent claims the benefit of U.S. Provisional Patent Application No. 63/447,852 by PORZIO et al., entitled “TECHNIQUES FOR EFFICIENT MEMORY SYSTEM PROGRAMMING,” filed Feb. 23, 2023, assigned to the assignee hereof, and expressly incorporated by reference in its entirety herein.

### TECHNICAL FIELD

The following relates to one or more systems for memory, including techniques for efficient memory system programming.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 illustrates an example of a system that supports techniques for efficient memory system programming in accordance with examples as disclosed herein.

FIG. 2 illustrates an example of a system that supports techniques for efficient memory system programming in accordance with examples as disclosed herein.

FIGS. 3A and 3B illustrate examples of command diagrams that supports techniques for efficient memory system programming in accordance with examples as disclosed herein.

FIG. 4 illustrates an example of a process flow that supports techniques for efficient memory system programming in accordance with examples as disclosed herein.

FIG. 5 illustrates a block diagram of a memory system that supports techniques for efficient memory system programming in accordance with examples as disclosed herein.

FIGS. 6 and 7 illustrate flowcharts showing a method or methods that support techniques for efficient memory system programming in accordance with examples as disclosed herein.

### DETAILED DESCRIPTION

Some memory systems may be programmed with data at various stages of being implemented into a larger system (e.g., a final product, a complete system). In some examples, a memory system may operate in a pre-soldering activity (PSA) programming mode, where the memory system may be programmed with data before being implemented (e.g., soldered) into the larger system, such as before being soldered (e.g., mounted) to a circuit board (e.g., printed circuit board (PCB)) for implementation into the larger system (e.g., such as a vehicle, an infotainment center, a smart phone, a smart watch, among other systems into which the memory system may be implemented). In another example, the memory system may be programmed via in-system programming (ISP) (e.g., a factory programming mode, a manufacturing programming mode), where the memory system may be programmed after, for example, being mounted to a circuit board for implementation into the larger system. In some cases, ISP may enable a manufacturing process of the memory system to integrate programming, testing, and assembly into a single production phase, for example, rather than using multiple production phases to support programming before system assembly (e.g., as with PSA programming). PSA and ISP programming operations may occur in a manufacturing setting. As such, increased latency associated with such programming operations may increase the cost of the memory system, for example, in terms of the quantity of memory systems that can be produced per day, time spent by technicians managing the programming of such memory systems, and the like. Thus, reducing the duration of these programming operations may be desired.

The techniques, devices, and methods described herein provide for more efficient programming operations, resulting in reduced costs, among other advantages. In some examples, a memory system may receive a programming command sequence indicative of operating in a programming mode (e.g., a PSA mode, an ISP mode) to write data to the memory system. For example, the memory system may receive a first command of the programming command sequence including an indication (e.g., a mode parameter) of the programming mode and indicating multiple logical block address (LBA) ranges for which data is to be received and written to the memory system. In accordance with the first command, the memory system may receive multiple second commands of the programming command sequence that each include respective data for a respective LBA range indicated by the first command. The memory system may write the respective data for the LBAs of the respective LBA range to physical addresses of the memory system. In some other examples, the memory system may set (e.g., set a register) equal to a value of a total quantity of LBAs for which data is to be received and written to the memory system while operating in the programming mode. The memory system may, in some examples, receive multiple commands to write data to physical addresses of the memory system, where based on each command to write data, the memory system may adjust (e.g., decrement) the value of the register in accordance with the quantity of LBAs written to as part performing the write command. In response to the value of the register reaching a given value, such as equaling zero, the memory system may exit the programming mode.

To reduce latency associated with the programming operations, the memory system may perform, disable, or delay one or more operations of the memory system that are associated with writing the data to the memory system to decrease programming times while operating in the programming mode. For example, the memory system may: disable or delay error correction operations, power loss management, or read checks; reallocate volatile memory for faster logical-to-physical (L2P) mapping information updates; or any combination thereof, among other operations described herein, to increase the performance of the programming mode, for example, by reducing or eliminating a latency associated with performing these operations. In this way, the memory systems (e.g., operating in the programming mode) may reduce the programming time, thereby decreasing costs associated with programming the memory system.

In addition to applicability in memory systems as described herein, techniques for improved efficient memory system programming may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of memory system programming by facilitating more efficient consecutive read operations, which may decrease processing or latency times, improve response times, or otherwise improve user experience, among other benefits.

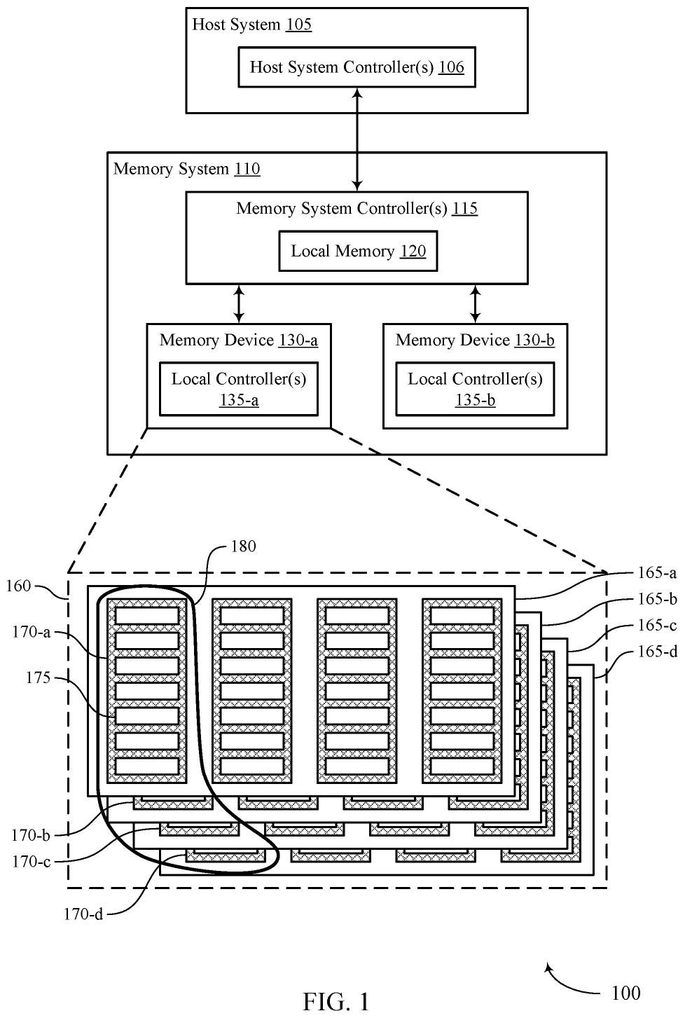

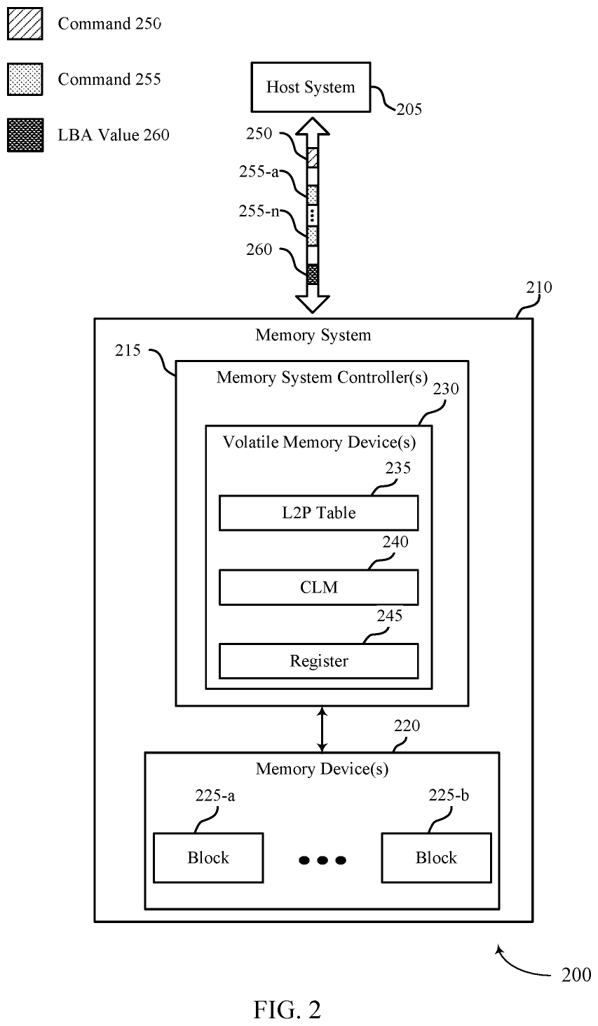

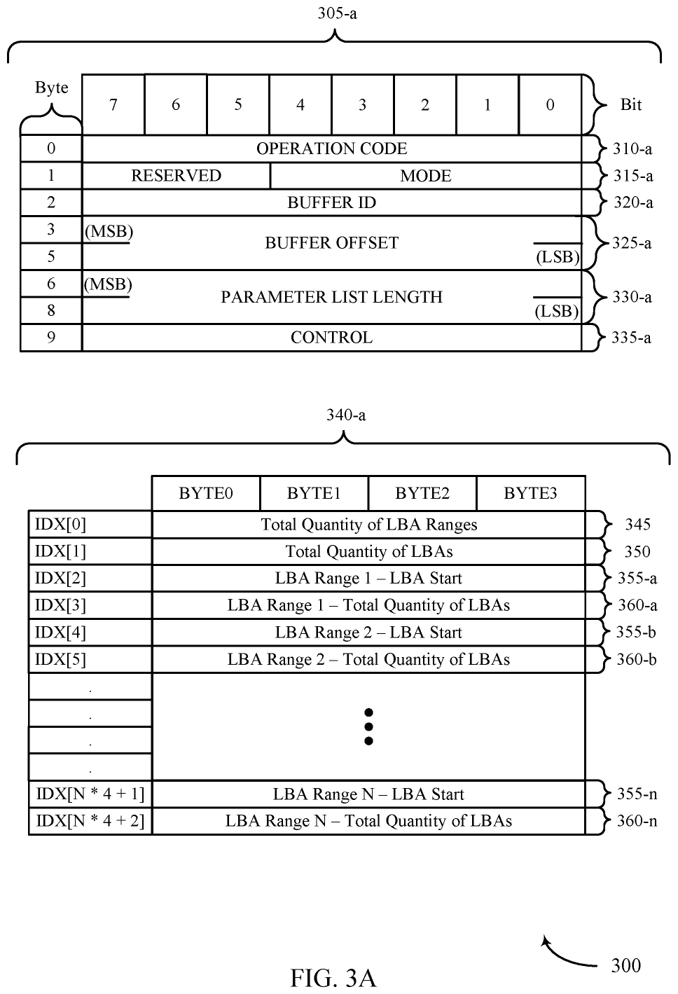

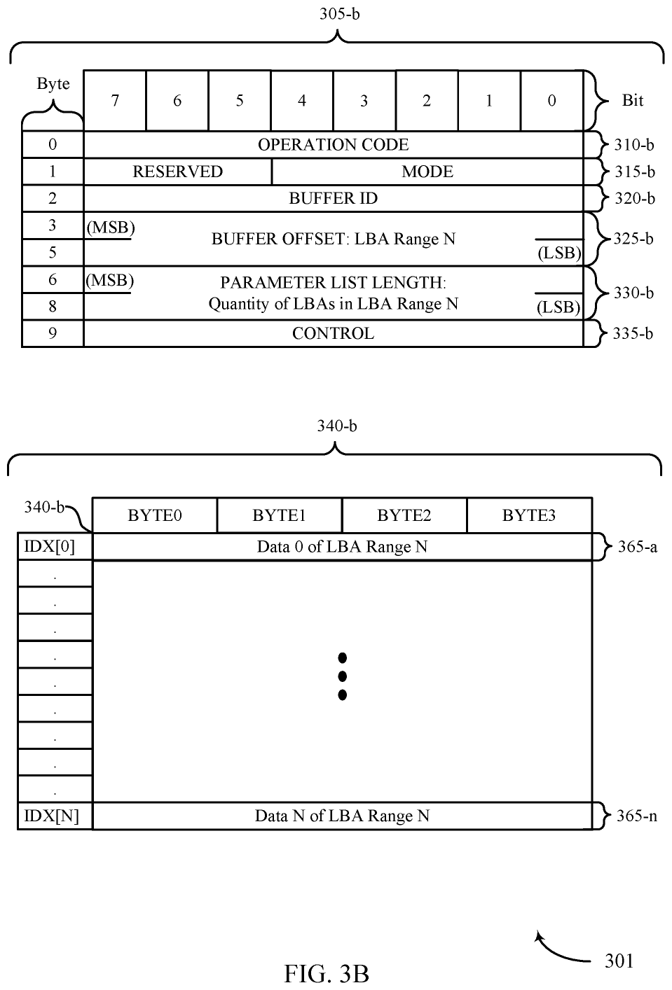

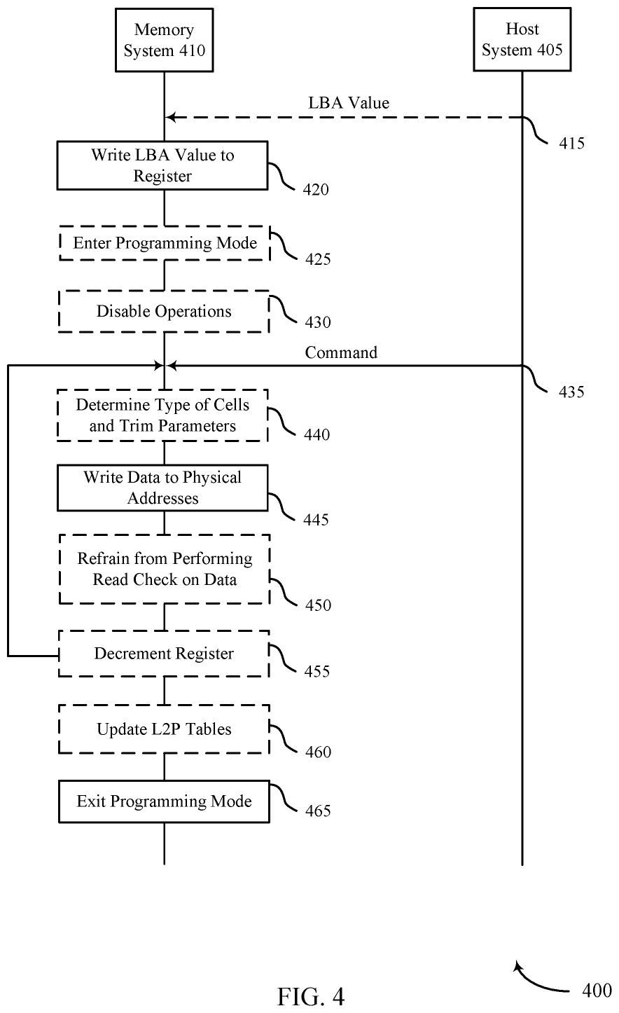

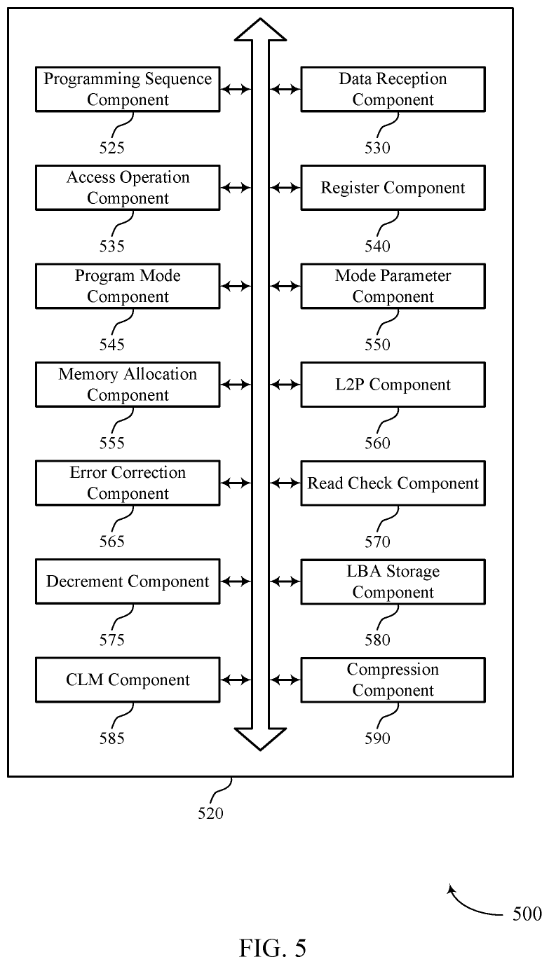

Features of the disclosure are initially described in the context of systems, devices, and circuits with reference to FIGS. 1 through 2. Features of the disclosure are described in the context of command diagrams with reference to FIGS. 3A through 3B. Features of the disclosure are described in the context of a process flow with reference to FIG. 4. These and other features of the disclosure are further illustrated by and described in the context of an apparatus diagram and flowchart that relate to techniques for efficient memory system programming with reference to FIGS. 5 through 7.

FIG. 1 illustrates an example of a system 100 that supports techniques for efficient memory system programming in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include one or more memory system controllers 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a L2P mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support techniques for efficient memory system programming. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

Some memory systems 110 may be programmed with data at various stages of being implemented into a larger system (e.g., a final product, a complete system). In one example, the memory system 110 may operate in a PSA programming mode, where the memory system 110 may be programmed with data before being implemented (e.g., soldered) into the larger system, such as before being soldered (e.g., mounted) to a circuit board (e.g., PCB) for implementation into the larger system (e.g., such as a vehicle, an infotainment center in a vehicle, a smart phone, a smart watch, among other systems into which the memory system 110 may be implemented). In another example, the memory system 110 may be programmed via an ISP (e.g., a factory programming mode, a manufacturing programming mode), where the memory system 110 may be programmed after, for example, being mounted to a circuit board for implementation into the larger system.

In accordance with examples described herein, a memory system 110 may receive a programming command sequence indicative of operating in a programming mode (e.g., a PSA mode, an ISP mode) to write data to the memory system 110. For example, the memory system 110 may receive a first command of the programming command sequence including an indication (e.g., a mode parameter) of the programming mode and indicating multiple logical block address (LBA) ranges for which data is to be received and written to the memory system 110. In accordance with the first command, the memory system 110 may receive multiple second commands of the programming command sequence that each include respective data for a respective LBA range indicated by the first command. The memory system 110 may write the respective data included in each second command to physical addresses corresponding the LBAs of the respective LBA range.

Alternatively, the memory system 110 may set a location, such as a register, equal to a value of the total quantity of LBAs for which data is to be received and written to the memory system 110 while operating in the programming mode. The memory system 110 may receive multiple commands to write data to physical addresses of the memory system 110 corresponding to the LBAs, where based on each write command, the memory system 110 may decrement the value of the register in accordance with the quantity of LBAs written to as part performing the write command. In response to the value of the register equaling zero, the memory system 110 may exit the programming mode.

To reduce latency associated with the programming operations, the memory system 110 may perform, disable, or delay one or more operations of the memory system 110 that are associated with writing the data to the memory system 110 to decrease programming times while operating in the programming mode. For example, the memory system 110 may: disable or delay error correction operations, power loss management, or read checks; reallocate volatile memory for faster L2P mapping information updates; or any combination thereof, among other operations described herein, to increase the performance of the programming mode, for example, by reducing or eliminating a latency associated with performing these operations. In this way, the memory systems 110 (e.g., operating in the programming mode) may reduce the programming time, thereby decreasing costs associated with programming the memory system 110.

FIG. 2 illustrates an example of a system 200 that supports techniques for efficient memory system programming in accordance with examples as disclosed herein. The system 200 may implement, or be implemented by, aspects of the system 100 as described herein. For example, the system 200 may include a host system 205, a memory system 210, a memory system controller 215, and a memory device 220, which may be examples of corresponding devices and systems described herein with reference to FIG. 1.

The memory system controller 215 may be coupled with the memory device 220 and configured to perform one or more access operations (e.g., such as read or write commands) on one or more physical addresses of blocks 225 (e.g., block 225-a through block 225-b) in the memory device 220. In some examples, the host system 205 may transmit a command to perform an access operation associated with one or more LBAs. For example, the host system may transmit an access command that includes data associated with one or more LBAs. In response, the memory system controller 215 may be configured to perform the access operation on the data (e.g., write the data to a physical address or read the data from the physical address) and update L2P tables to indicate to which physical addresses the data for the LBAs is written (e.g., as part of a write operation).

The memory system controller 215 may allocate a portion of a volatile memory device 230 (e.g., a local memory 120) for updating L2P tables 235. The L2P tables 235 may include a mapping between LBAs and physical addresses of the memory device 220. Thus, upon performing an access operation, the memory system controller 215 may load a portion of the L2P tables 235 into the volatile memory device 230 (e.g., from non-volatile memory), such that the memory system controller 215 may perform updates to the L2P tables 235. Such L2P tables may be an example of, or referred to as, physical pointer tables (PPTs). However, in some cases, loading a portion of the L2P table 235 in response to each access command may increase latency, use of resources, or both. Thus, the volatile memory device 230 may include a change log manager (CLM) 240, which may be used to log or manage the LBA to physical address mapping while operations are being performed. For example, during multiple access operations, the memory system controller 215 may update the CLM 240 with corresponding LBA to physical address mappings, and, upon completion of such access operations, load a portion of the L2P tables 235 into the volatile memory device and update the L2P mapping information in accordance with the information in the CLM 240.

The host system 205 and memory system 210 may be coupled via an interface, such that each device may communicate data, commands, requests, or the like. In an example, the host system 205 may transmit, via the interface, a write command to the memory system 210. The memory system controller 215 may receive and process such commands write data to one or more blocks 225 (e.g., virtual blocks 180, blocks 170) of the memory device 220. In another example, the host system 205 may transmit a read command, instructing the memory system 210 to retrieve and transmit data to the host system 205. In such examples, the memory system controller 215 may retrieve the requested data from one or more blocks 225 of the memory device 220 and transmit the requested data to the host system 205 via the interface.

In some examples, the host system 205 may be, or be a part of, a manufacturing system operable to program the memory system 210 with data before (e.g., as part of) the memory system being implemented into a larger system (e.g., such as a final product, customer host system, or the like). For example, the memory system 210 may operate in a PSA programming mode, where the memory system 210 may be programmed, by the host system 205, with data before being implemented (e.g., soldered) into the larger system (e.g., such as a car, phone, smart watch, or the like). In some examples, the memory system 210 may operate in an PSA programming mode, where the memory system 210 may be programmed with data before being implemented (e.g., soldered) into the larger system, such as before being soldered (e.g., mounted) to a circuit board (e.g., printed circuit board (PCB) for implementation into the larger system. In some examples, the memory system 210 may operate in an ISP mode, where the memory system 210 may be coupled with (e.g., soldered to, mounted to) a PCB (e.g., a customer system) and programmed with data before being implemented into the final product or before being provided to the customer. Such operations (e.g., ISP or PSA programming) may be performed in a manufacturing setting (e.g., factory environment), for example, before providing the memory system 210 to customers. As such, if there are a relatively large quantity of memory systems 210 to be programmed, each second spent in the programming stage may affect the cost of the memory system 210. That is, the time spent to program such memory systems 210 in the manufacturing setting may result in increases to costs, money, and resources, for example, in terms of a quantity of technicians managing the programming, a quantity of programmers, a quantity of memory systems 210 to be programmed (e.g., ready) per day, or the like. As such, it may be desirable to reduce the duration of such programming operations (e.g., reduce programming time to be as minimum as possible).

The system 200 may support a programming mode (e.g., a manufacturing programming mode, such as an ISP or PSA mode) that reduces the latency associated with programming data to the memory system 210 while operating in the programming mode. For example, to achieve quicker throughput and reduced latency for such programming modes (e.g., ISP and PSA operations), the memory system 210 may write data in accordance with a programming command sequence. For instance, the memory system 210 may receive a command for ISP or PSA programming (e.g., either a command 250 or a LBA value 260), where the command for ISP or PSA programming may include a total quantity of LBAs associated with the programming mode, an indication of multiple LBA ranges (e.g., respective LBA start addresses and quantities of LBA ranges for each LBA range), or both. In accordance with the command, the memory system 210 may receive write commands and program the memory system 210 with the data. While operating in the PSA or ISP modes, the memory system 210 may perform, disable, or delay one or more operations in order to improve performance, as described with reference to FIGS. 3A through 4. For example, the memory system 210 may perform L2P updates before writing data to the physical addresses of the memory system 210. Further, the memory system may disable, or otherwise delay, power loss management, CLM 240 operation, L2P table 235 management (e.g., concurrent with or after writing the data), background operations, parity checks, read checks, or the like.

In some examples, the memory system 210 may be programmed as part of a programming command sequence. For example, the memory system 210, while operating in a programming mode (e.g., ISP, PSA, or the like), may receive a command 250 from the host system 205, where the command 250 may be a first (e.g., initial) command in the programming command sequence. In some examples, the command 250 may trigger the memory system 210 to operate in the programming mode, where, in response to receiving the command 250, the memory system 210 may enter the programming mode. Further, the command 250 may indicate a total quantity of LBA ranges associated with the programming command sequence, a total quantity of LBAs associated with the total quantity of LBA ranges, a respective starting LBA for each LBA range, a total quantity of LBAs in each respective LBA range, or a combination thereof, as described with reference to FIG. 3A.

In response to receiving the command 250, the memory system 210 may perform, delay, or otherwise disable, one or more operations in order to improve performance of the programming operations. For example, the memory system 210 may disable the CLM 240 of the volatile memory device 230, one or more error correction procedures of the memory system 210, read checks, or any combination thereof. In such examples (e.g., disabling the CLM 240), the memory system 210, in response to receiving the command 250, may release one or more resources of the volatile memory device 230 (e.g., releasing all of the resources of the volatile memory device 230) to load (e.g., transfer) respective portions of the L2P table 235 to the volatile memory device 230 and update the L2P table 235 before receiving the one or more commands 255 (e.g., before writing the data to the physical addresses of the memory device 220). In this way, the memory system 210 may disable the CLM 240 in order to perform the programming operation efficiently, thereby reducing programming time. In some other examples, the memory system 210 delay updating the L2P table 235 until after the completion of the programming command sequence or after the completion of a respective command 255. In cases, the memory system 210 may refrain from disabling the CLM 240 if delaying updating the L2P table 235. Additionally or alternatively, the memory system 210 may determine a type of memory cell to which to write data while in the programming mode, trim parameters for writing to the type of memory cell, or a combination thereof. Additional details related to performing, disabling, or otherwise delaying, operations in association with the performing the programming command sequence are described with reference to FIGS. 3A and 3B below.

In accordance with the information received via the command 250, the memory system 210 may receive multiple commands 255 (e.g., command 255-a through command 255-n), where each command 255 includes data associated with a respective LBA range. The memory system controller 215 may be configured to receive and process (e.g., perform) such commands 255 using the volatile memory device 230. As an illustrative example, the memory system 210 may receive a command 255-a, where the command 255-a may include data associated with a first LBA range of the total quantity of LBA ranges indicated in the command 250. The memory system controller 215 may write the data associated with the first LBA range to physical addresses of one or more of the blocks 225 of the memory device 220. The memory system 210 may receive and perform such commands 255 until data associated with the total quantity of LBA ranges has been written to the memory device 220. Such techniques (e.g., the programming command sequence and command 250 and commands 255) may be further described herein with reference to FIGS. 3A through 3B.

In some other examples, the memory system 210, while operating in an ISP or PSA programming mode, may perform the programming operations while managing a register 245 (e.g., bFastProgramCount register). For example, the memory system 210 may receive an LBA value 260 that indicates the total quantity of LBAs associated with the programming operations. In response to receiving the LBA value 260, the memory system controller 215 may be configured to write the LBA value 260 to the register 245 and accept any subsequent write commands.

In order to improve performance of such programming operations, the memory system 210 may perform, delay, or otherwise disable, one or more operations in response to receiving the LBA value 260 and writing the LBA value 260 to the register 245. For example, the memory system 210 may disable operations of the CLM 240, one or more error correction procedures of the memory system 210, read checks, or any combination thereof. Additionally or alternatively, the memory system 210 may determine a type of memory cell to which to write while in the programming mode, trim parameters for writing to the type of memory cell, or a combination thereof. Additional details related to performing, disabling, or otherwise delaying, operations in association with the performing the programming operations while managing the register 245 are described with reference to FIG. 4 below.

Further, after (e.g., in response to) receiving the LBA value 260 and writing the LBA value 260 to the register 245, the memory system 210 may receive multiple commands (e.g., commands 255) to write data associated with the quantity of LBAs to physical addresses of the memory device 220, where the physical addresses correspond to one or more LBAs indicated in each write command. After (e.g., in response to) completing a respective write command, the memory system controller 215 may decrement the value in the register 245, such that in response to the value of the register 245 being decremented to zero, the memory system 210 may exit the programming mode (e.g., ISP or PSA mode), thereby completing the programming operations. For example, the memory system 210 may receive a first write command and decrement the value of the register 245 in accordance with a quantity of LBAs written to as part performing the first write command. The memory system 210 may decrement the value of the register 245 based on the first write command (e.g., after receiving the first write command, after executing the first write command). Such techniques (e.g., writing the LBA value 260 to the register 245 and performing write operations accordingly) may be further described herein with reference to FIG. 4.

FIGS. 3A and 3B illustrate examples of a command diagram 300 and a command diagram 301 that support techniques for efficient memory system programming in accordance with examples as disclosed herein. The command diagram 300 and command diagram 301 may be implemented by aspects of the system 100 and the system 200 as described herein. For example, the command diagram 300 and the command diagram 301 may include a header 305-a and a header 305-b, respectively, which may represent command descriptor block (CDB) headers used for one or more commands (e.g., for command 250 and commands 255) in a programming command sequence described herein with reference to FIG. 2. The command diagram 300 and the command diagram 301 may also include data 340-a and data 340-b, which may represent the data portion associated with the command 250 and commands 255, respectively, as described herein, including with reference to FIG. 2.

The command diagram 300 and the command diagram 301 may be implemented by a host system (e.g., such as host system 205) that is part of a manufacturing programming system and configured to program a memory system (e.g., such as a memory system 210). The host system may program the memory system via a first command (e.g., such as a command 250), that includes the header 305-a and the data 340-a, and subsequent second commands (e.g., such as commands 255), where such second commands include the header 305-b and the data 340-b. Such program operations may be referred to as a programming command sequence. That is, the first command and the second commands may constitute the programming command sequence.

The programming sequence may be composed of two steps, where, in a first step, the memory system may receive the first command (e.g., a command 250), which may be referred to as an LBA table write buffer command, where the LBA table write buffer command includes the header 305-a and data 340-a. In a second step, the memory system may receive the multiple second commands (e.g., commands 255), which may be referred to as data contents write buffer commands, where the data contents write buffer commands include the header 305-b and the data 340-b. The commands (e.g., first command and second commands) may use a WRITE_BUFFER command structure, where the headers 305 of the commands include a dedicated mode parameter that is indicative of the commands being included in the programming command sequence (e.g., that the commands are to be executed by the memory system while operating in a programming mode). The dedicated mode parameter may be defined according to a standards body (e.g., such as a Joint Electron Device Engineering Council (JEDEC) standard) or may be a value that indicates a special vendor mode command (e.g., such as 01h).

As shown in FIG. 3A, the memory system may receive the first command that includes the header 305-a and data 340-a, where the first command may be an indication to the memory system that the programming command sequence (e.g., ISP stage) is to begin (e.g., has begun, an indication for the memory system to enter the programming mode). The header 305-a may include various bytes of data (e.g., bytes 0 through 9), where one or more bytes may include information associated with the programming command sequence. For example, the header 305-a may include an operation code 310-a in byte 0, a mode 315-a in a portion of byte 1 (e.g., bits 4 through 0 of byte 1), a buffer identifier 320-a in byte 2 a buffer offset 325-a in bytes 3 through 5, a parameter list length 330-a in bytes 6 through 8, and a control parameter 335-a in byte 9. As illustrated, the buffer offset 325-a and the parameter list length 330-a may be indicated via multiple bytes. In the example of FIG. 3A, the most significant bit (MSB) of the buffer offset 325-a may correspond to bit 7 of byte 3 (e.g., the MSB of byte 3), while a least significant bit (LSB) may correspond to bit 0 of byte 5 (e.g., the LSB of byte 5). Similarly, the MSB of the parameter list length 330-a may correspond to bit 7 of byte 6 (e.g., the MSB of byte 6), while the LSB may correspond to bit 0 of byte 8 (e.g., the LSB of byte 8). It is noted that the respective bit quantities and locations within the header 305-a for the various parameters are examples provided for illustrative clarity and that other bit quantities and locations within the header 305-a are possible.

The memory system may use one or more values of such parameters to determine that the first command is a part of the programming command sequence. As an illustrative example, the header 305-a may include an operation code 310-a with a value of 3Bh (e.g., indicating a type of the command, such as a write buffer command), a mode 315-a with a value of 01h, a buffer identifier (ID) with a value of AAh, a buffer offset 325 with a value of 00h, and a parameter list length 330-a that corresponds to the data buffer size (e.g., a size of the data 340-a). In such an example, the mode 315-a with a value of 01h may be referred to as a dedicated mode parameter. The memory system may determine that the first command is associated with the programming command sequence in accordance with the value of the mode 315-a in the header 305-a of the first command. That is, the mode 315-a may indicate that the first command is a part of the programming command sequence (e.g., that the memory system is to enter the programming mode). As such, the mode 315-a with a dedicated value (e.g., such as 01h) may be referred to as a dedicated mode parameter. It should be understood that the mode 315-a may include a variety of other values in order to indicate the programming command sequence is to begin, where such values may be defined in a standards body (e.g., a JEDEC standard, among others) or by a vendor or operator of the memory system.

In some examples, the data 340-a (e.g., the data buffer) of the first command may be transmitted using a real-time transport (RTT) protocol. The data 340-a of the first command may exclude data to be written to the memory system and may instead indicate LBA ranges to be programmed in the second step of the programming command sequence (e.g., indicate LBA ranges associated physical addresses that are to be programmed in the memory system). In some examples, the values for the buffer ID and the buffer offset in the header 305-a may be unused by the memory system, for example, because the data 340-a excludes data to be written to the memory system. The data 340-a may be represented by various bytes of data (e.g., bytes 0 through 3) and organized according to one or more indexes (e.g., IDX[0] through IDX N*4+2]). The memory system may use the indexes to identify information associated with the programming sequence.

For example, the data 340-a may indicate a total quantity of LBA ranges 345 that are to be programmed in the memory system at index 0 (e.g., IDX [0]), a total quantity of LBAs 350 of the total quantity of LBA ranges 345 at index 1 (e.g., IDX [1]), and a list of N LBA ranges at index 3 through index N (e.g., IDX [3] through IDX[N*4+2]). Further, the data 340-a may indicate, for each LBA range of the N LBA ranges (e.g., LBA range 1 through LBA range N), a starting address 355 and a total quantity of LBAs 360 in each LBA range. For example, the data 340-a may include a starting address 355-a for a first LBA range and a total quantity of LBAs 360-a associated with (e.g., included in) the first LBA range. Similarly, the data 340-a may include a starting address 355-b and a total quantity of LBAs 360-b associated with a second LBA range, and so on. The data 340-a may include such information (e.g., starting address 355 and total quantity of LBAs 360) for each LBA range that is to be programmed (e.g., through the Nth LBA range with associated starting address 355-n and total quantity of LBAs 360-n).

In response to the memory system receiving the first command (e.g., the LBA ranges), the memory system may enter (e.g., activate) a mode of operation (e.g., enter the programming mode in response to receiving the first command) in order to write data for the indicates LBA ranges with reduced latency. In some examples, the memory system may release one or more resources of volatile memory to use for L2P updates. For example, the memory system may allocate portions of (e.g., an entirety of) a volatile memory device (e.g., SRAM, a volatile memory device 230, local memory 120) to use in temporarily storing and updating portions of an L2P table (e.g., L2P table 235). That is, because the memory system receives an indication of the starting addresses 355 and the total quantity of LBAs 360 for each LBA range in the first command, the memory system may release resources from volatile memory (e.g., SRAM, a volatile memory device 230, local memory 120), such that the memory system may perform L2P updates (e.g., update L2P mapping information for the indicated LBAs) before writing data in the second step of the programming command sequence (e.g., before receiving the second commands that include respective headers 305-b and data 340-b).

Additionally, based on performing the L2P updates before writing the data, the memory system may disable operations associated with change log management, change log maintenance, L2P updates during or after writing the data, or the like (e.g., disable a CLM hardware engine, PPT management, or both). In this way, the memory system may bypass logging the changes of the LBA to physical address mapping in the CLM 240 (e.g., bypass using the CLM 240) or performing L2P updates while or after performing the write operations, thereby improving program efficiency. For example, latency associated with disabling these operations may be reduced or eliminated, which may reduce an overall latency associated with writing the data.

Additionally or alternatively, because the memory system receives an indication of each LBA range and associated starting address in the data 340-a, the memory system may compress sequential LBA ranges indicated in the data 340-a of the first command. For example, data 340-a may indicate that the first LBA range and the second LBA range are sequential (e.g., contiguous, a first LBA of the second LBA range is a next LBA after a last LBA of the first LBA range). As such, the memory system may compress the first and second LBA ranges and update the compressed ranges in the L2P table. In some examples, the memory system may compress up to 4 megabytes (MB) of LBA ranges. Further, in order to compress such sequential LBA ranges, the memory system enable direct memory access (DMA) engines to compress sequential LBA ranges.

In accordance with the information received in the data 340-a of the first command, the memory system may have an indication of total programming size, a quantity of blocks (e.g., blocks 225) to be allocated (e.g., to which data is to be written), and whether the blocks are to be full or partial blocks (e.g., after being written with the data). As such, at the time of performing the write operations, the memory system may further perform one or more operations to program the data with reduced latency. For example, as described herein, the memory system may disable L2P management (PPT management) and a CLM (e.g., CLM 240) in response to performing the L2P updates before receiving the second commands. That is, if the memory system performs updates to L2P tables in response to receiving the first command, and before receiving the one or more second commands, the memory system may disable L2P management and the of the memory system in association with (e.g., while) writing the data for the indicated LBAs.

Additionally or alternatively, the memory system may disable one or more error correction procedures associated with writing the data, such as the generation of error correction code (ECC) data, parity data, redundancy data, or any thereof. For example, the memory system may perform the one or more error correction procedures to support error correction in association with subsequently reading the data. For instance, in conjunction with writing the data, the memory system may generate and store ECC data, parity data, redundancy data (e.g., a copy of the data), or any combination thereof, such that, if there are errors associated with subsequently reading the data, the memory system may be able to compensate for the errors and correctly read the data. To reduce a latency associated with writing the data, the memory system may disable (e.g., refrain from performing) the one or more error correction procedures such that the latency associated with performing the error correction procedures may be eliminated. Due to the disablement of the one or more error correction procedures, the memory system may consider the programming command sequence (e.g., writing data to the memory system) as an atomic operation, where either the memory system is programmed with all the data or an error is reported while programming and the programming command sequence restarts.

In some examples, in accordance with the total quantity of LBAs 360 associated with each respective LBA range, the memory system (e.g., firmware of the memory system) may determine a programming technique to increase overall data programming throughput. That is, the memory system may determine a type of memory cell to which to write the data, such as a single level cell (SLC), a tri-level cell (TLC), or some other multiple-level cell (e.g., a memory cell configured to store two or more bits of information). For example, the fewer the bits stored per memory cell, the smaller a latency associated with writing to the memory cell. For instance, the memory system may write data to SLCs faster than it can write data to multiple-level cells. However, SLCs may be less storage efficient than multiple-level cells. As such, based on the quantity of data to be written (e.g., the total quantity of LBAs 360), the memory system may determine the type of memory cell to which to write the data. For example, if the quantity of data is below a threshold, the memory system may determine to write the data to SLCs to support a reduced latency associated with writing the data. Alternatively, if the quantity of data is above the threshold, the memory system may determine to write the data to a multiple-level cells, such as TLCs, to increase a storage efficiency associated with writing the data.

In some examples, the memory system may determine one or more trim parameters associated with writing the data to the memory cells of the determined type. For example, the memory system may determine voltage levels, pulse durations, pulse quantities, and/or timing parameters, among other types of trim parameters according to which data may be written to the memory cells. In some examples, the one or more trim parameters may be specific to writing while operating in the programming mode (e.g., writing data as part of the programming command sequence). For example, the one or more trim parameters may be selected to reduce a latency associated with writing data (e.g., shorter pulse durations, fewer pulses, and so on).

Additionally or alternatively, the memory system may determine to refrain from performing (e.g., skip) read checks (e.g., read back checks). Read checks may be the process of reading the data after performing the write operation in order to verify whether the data was written correctly. As such, by determining to refrain from performing such read checks, the memory system may more efficiently program the memory system in the ISP or PSA mode, for example, by eliminating latency associated with performing the read checks.

The memory system may perform, disable, or delay, such operations in accordance with the memory system operating in a manufacturing setting. For example, due to the ideal operating conditions associated with operating in a manufacturing setting (e.g., the memory system may be new, or otherwise lightly used, connected to a power source, operating in a temperature-controlled environment, or the like), the likelihood of error during the programming operations may be reduced. In this way, the memory system may perform, disable, or delay such operations in order to improve efficiency and reduce latency associated with writing the data.

By enabling or disabling the aforementioned operations, the memory system may receive the data to be programmed (e.g., via the second commands as illustrated in FIG. 3B) and program the data to the physical addresses associated with the LBAs (e.g., to the blocks of memory) efficiently and sequentially, resulting in reduced costs. That is, the time spent programming the memory system in the PSA or ISP modes may be reduced, thereby reducing costs and resources associated with factory programming of the memory system.

In response to, or concurrently with, enabling or disabling the aforementioned operations, the memory system may perform the second step of the programming command sequence. The second step of the programming command sequence may include the memory system receiving a series of second commands (e.g., WRITE_BUFFER commands as defined in the small computer system interface (SCSI) specification), which may provide the data to be programmed in multiple steps. That is, each second command may be associated with respective data for each LBA range of the total quantity of LBA ranges 345 indicated in header 305-a of the first command. As shown in FIG. 3B, each second command may include a header 305-b and data 340-b, where the header 305-b may define the respective LBA range for which the data 340-a is intended.

The header 305-b, of each second command, may include various bytes of data (e.g., bytes 0 through 9), where one or more bytes may include information associated with the data of each second command. For example, the header 305-b may include an operation code 310-b in byte 0, a mode 315-b in a portion of byte 1 (e.g., bits 4 to 0 of byte 1), and a buffer identifier 320-b in byte 2 a buffer offset 325-b in bytes 3 through 5, a parameter list length 330-b in bytes 6 through 8, and a control parameter 335-b in byte 9. As illustrated, the buffer offset 325-b and the parameter list length 330-b may be indicated via multiple bytes. In such examples, the MSB of the buffer offset 325-b may correspond to bit 7 of byte 3, while the LSB may correspond to bit 0 of byte 5. Similarly, the MSB of the parameter list length 330-b may correspond to bit 7 of byte 6, while the LSB may correspond to bit 0 of byte 8. Similar to the first command, the memory system may determine (e.g., identify) that each second command is part of the programming command sequence based on the mode 315-b. For example, the mode 315-b may have a value that is the same as the value of mode 315-a in the first command. As such, the memory system may determine that the second command, with corresponding data 340-b, is with a part of the programming command sequence.

Further, the buffer offset 325-b of the header 305-b may indicate for which LBA range the data 340-b is intended. As an illustrative example, the header 305-b may include a buffer offset 325-b that indicates the first LBA range (e.g., indicated by the starting address 355-a and the total quantity of LBAs 360-a). As such, the memory system may determine that the data 340-b is intended for the first LBA range. Additionally, the parameter list length 330-b may indicate the total quantity of LBAs in the LBA range indicated by the buffer offset 325-b. Continuing the illustrative example, if the buffer offset 325-b indicates that the data 340-b is intended for the first LBA range, then the parameter list length 330-b may indicate the total quantity of LBAs for the first LBA range (e.g., the total quantity of LBAs 360-a).

The data 340-b of each second command may be transmitted, from the host system to the memory system, using the RTT protocol and may contain the data to be programmed during the programming command sequence. The data 340-b of each second command may include all the data for the LBA range indicated in the buffer offset 325-b of the associated header 305-b (e.g., data 365-a through data 365-n of LBA range N). As illustrated in FIG. 3B, the data 340-b may contain one or more indexes, where each index is four bytes in length (e.g., bytes 0 through 3). The data 340-b of each command may start with data 365-a associated with the first LBA address indicated in the data 340-a of the first command. That is, the first index in the data 340-b (e.g., IDX[0]) may include data for one or more LBAs beginning with the first LBA address (e.g., the starting address 355-a) of the first LBA range. Accordingly, the data 340-b may include the data associated with the LBA range indicated in the buffer offset 325-b via the various indexes (e.g., IDX[0] through IDX[N]).

In response to receiving each second command, the memory system may write the data 340-b to one or more physical addresses of the memory system associated with the indicated LBA ranges. The memory system may perform such operations in accordance with enabling, or disabling, of the aforementioned features. For example, the memory system may write the data to the physical addresses to which the data was mapped as part of updating the L2P table in response to receiving the first command. In some examples, instead of updating the L2P tables before writing the data, the memory system may update the L2P tables in response to completing each second command of the multiple second commands. That is, the memory system may receive the first command indicating each LBA range to be programmed, receive multiple second commands include data 340-b associated with a respective LBA range, and write the data 340-b in accordance with each second command. In response to completing each second command of the multiple second commands, the memory system may update corresponding portions (e.g., entries) of the L2P table. In some other examples, instead of updating the L2P table before writing the data, the memory system may update the L2P table after completing (e.g., executing) the multiple second commands.

The techniques described in FIGS. 3A and 3B may enable the memory system to efficiently program the memory system operating in an ISP or PSA mode in accordance with a programming command sequence and enabling or disabling one or more operations of the memory system. In this way, the memory system may reduce the time spent in such programming modes, thereby reducing costs of, and resources used for, programming the memory system.

FIG. 4 illustrates an example of a process flow 400 that supports techniques for efficient memory system programming in accordance with examples as disclosed herein. The process flow 400 may implement, or be implemented by, aspects of the system 100 and the system 200 as described herein. For example, the process flow 400 may be implemented by a host system 405 and a memory system 410, which may be examples of host systems and memory systems as described herein with reference to FIGS. 1. and 2. Additionally, or alternatively, aspects of the process flow 400 may be implemented as instructions stored in memory (e.g., firmware stored in a memory coupled with the memory system). For example, the instructions, when executed by the controller (e.g., the memory system controller 215), may cause the controller to perform the operations of the process flow 400. The process flow 400 may support techniques for efficient memory system programming using a register.

At 415, an LBA value (e.g., an LBA value 260) may be received. For example, the memory system 410 may receive, from the host system 405, the LBA value, where the LBA value indicates a total quantity of LBAs associated with writing data while operating in a programming mode. That is, the LBA value may indicate the total quantity of LBAs to be written while the memory system operates in the programming mode (e.g., PSA mode, ISP mode).

At 420, the LBA value may be written to a register. For example, the memory system 410 may allocate resources of a volatile memory device for the register (e.g., a register, 245, a bFastProgramLbaCount register). The register may be set to zero as a default value and be volatile, such that in case the memory system powers down or experiences power loss, the register may be reset to zero. In response to receiving the LBA value, the memory system may write the LBA value to the register.

At 425, the programming mode may be entered. For example, in response to receiving the LBA value (e.g., and writing the LBA value to the register), the memory system 410 may enter the programming mode. That is, before entering the programming mode, the memory system 410 may be expected to write the LBA value into the register. The memory system 410 may use the reception of the LBA value and setting of the register to be equal to the LBA value in order to start the programming mode. While in the programming mode (e.g., while the value of the register is greater than zero), the memory system 410 may accept all subsequent write commands regardless of the size or LBA ranges of the write commands.

At 430, one or more operations may be delayed or disabled. For example, in response to entering the programming mode, the memory system 410 may disable, or delay, one or more operations associated with writing the data to the memory system. For instance, the memory system 410 may disable one or more error correction procedures, such as the generation of error correction code data, parity data, redundancy data, or the like. In some examples, the memory system 410 may delay updating L2P mapping information (e.g., an L2P table 235) until after completion of the programming operations (e.g., until after writing data for the total quantity of LBAs).

At 435, multiple commands may be received. For example, the host system 405 may transmit (e.g., send), and the memory system 410 may receive a series of write commands in order to program the memory system 410. That is, the memory system 410 may receive multiple write commands to write data associated with the LBA value (e.g., quantity of LBAs) indicated at 415. In some examples, each write command of the multiple write commands may be an example of a WRITE_10 or WRITE_16 command (e.g., in accordance with a Small Computer System Interface (SCSI) standard). In some examples, a respective write command of the multiple write commands may include data for multiple LBAs (e.g., a range of LBAs).

As an illustrative example, at 435, the host system 405 may transmit a command to write data to physical addresses of the memory system associated with a portion of (e.g., one or more LBAs of) the total quantity of LBAs indicated by the LBA value.

At 440, types of cells and trim parameters of such cells may be determined. For example, in response to receiving the command at 435, the memory system 410 may determine a type of memory cell to which to write data, one or more trim parameters associated with writing the data, or both, where such determinations may be in accordance with a size of the data associated with the command. For example, if the quantity of data is below a threshold, the memory system 410 may determine to write the data to SLCs to support a reduced latency associated with writing the data. Alternatively, if the quantity of data is above the threshold, the memory system 410 may determine to write the data to a multiple-level cells, such as TLCs, to increase a storage efficiency associated with writing the data. In some examples, the memory system 410 may determine trim parameters for writing to the type of memory cell, which, in some cases, may be specific to writing while operating in the programming mode. For example, the memory system 410 may select the trim parameters to reduce a latency associated with writing data (e.g., shorter pulse durations, fewer pulses, and so on).

At 445, data may be written to physical addresses of the memory system 410. For example, the memory system 410 may write the data for the one or more LBAs indicated in the write command to the physical addresses. The memory system 410 may perform the write operation in accordance with the determined cell type and trim parameters.

At 450, one or more read checks may not be performed. For example, in response to writing the data, the memory system 410 may refrain from performing (e.g., skip performing) one or more read checks on the data written to the physical addresses in response to operating in the programming mode. That is, in order to efficiently program the memory system 410 while operating in the programming mode, the memory system may skip the performance of read checks on the data, thereby reducing time associated with each write operation.

At 455, the register may be decremented. That is, in response to writing the data to the physical address in accordance with the command, the memory system 410 may decrement the value of the register by the quantity of LBAs associated with the write command. As an illustrative example, a first write command, at 435, may indicate a first quantity of LBAs to be written. Accordingly, the memory system 410 may decrement the value of the register by the first quantity of LBAs (e.g., value of register minus the first quantity of LBAs). The memory system 410 may perform such operations (e.g., 435-455) until the register value is equal to zero. That is, the memory system 410 may maintain the register by decrementing the value of the register as each command is performed. In some examples, the memory system 410 may decrement the register upon receiving the write command at 435, but before performing the write operations at 445. In some other examples, the memory system 410 may decrement the register in concurrence with or after the write operation at 445.

At 460, L2P tables may be updated. For example, after or as part of performing each write command, the memory system 410 may store, to a volatile memory device of the memory system 410, the LBAs associated with each write command. Thus, upon completion of the write commands associated with the programming mode, the memory system 410 may update the L2P mapping information (e.g., L2P table 235) in order to maintain a mapping between the LBAs and the physical addresses of the memory system 410. In some examples, the memory system 410 may store updated L2P mapping information in a CLM managed in the volatile memory device. For example, the memory system 410 may write entries to the CLM that indicate the updated L2P mapping information for the LBAs.

At 465, the programming mode may be exited. For example, the memory system 410 may exit the programming mode in response to the value of the register reaching zero, which signifies that the data associated with the programming mode has been written. That is, once the sum of the quantity of LBAs associated with each write command reaches the initial value of the register (e.g., the LBA value), the memory system 410 may end (e.g., exit) the programming mode. The techniques, methods, and devices as described in FIG. 4 may enable the memory system 410 to efficiently program the memory system, thereby reducing costs and resources associated with programming the memory system 410.

FIG. 5 illustrates a block diagram 500 of a memory system 520 that supports techniques for efficient memory system programming in accordance with examples as disclosed herein. The memory system 520 may be an example of aspects of a memory system as described with reference to FIGS. 1 through 4. The memory system 520, or various components thereof, may be an example of means for performing various aspects of techniques for efficient memory system programming as described herein. For example, the memory system 520 may include a programming sequence component 525, a data reception component 530, an access operation component 535, a register component 540, a program mode component 545, a mode parameter component 550, a memory allocation component 555, a L2P component 560, an error correction component 565, a read check component 570, a decrement component 575, an LBA storage component 580, a CLM component 585, a compression component 590, or any combination thereof. Each of these components may communicate, directly or indirectly, with one another (e.g., via one or more buses).

The programming sequence component 525 may be configured as or otherwise support a means for receiving, as part of a programming command sequence, a first command indicating a plurality of LBA ranges associated with a memory system. The data reception component 530 may be configured as or otherwise support a means for receiving, as part of the programming command sequence, a plurality of second commands, each second command including respective data associated with a respective LBA range of the plurality of LBA ranges. The access operation component 535 may be configured as or otherwise support a means for writing, for each respective LBA range, the respective data to physical addresses of one or more memory devices of the memory system in accordance with the plurality of second commands.

In some examples, to support receiving the first command, programming sequence component 525 may be configured as or otherwise support a means for receiving an indication of a total quantity of LBA ranges of the plurality of LBA ranges, a total quantity of LBAs of the plurality of LBA ranges, a respective starting LBA for each LBA range of the plurality of LBA ranges, a respective total quantity of LBAs for each LBA range of the plurality of LBA ranges, or any combination thereof.

In some examples, the mode parameter component 550 may be configured as or otherwise support a means for determining whether the first command is part of the programming command sequence based at least in part on a mode parameter included in the first command, the mode parameter associated with a programming mode of the memory system.

In some examples, the mode parameter component 550 may be configured as or otherwise support a means for determining, for each second command of the plurality of second commands, whether the second command is part of the programming command sequence based at least in part on a mode parameter included in the second command, the mode parameter associated with a programming mode of the memory system.

In some examples, to support receiving the plurality of second commands, the data reception component 530 may be configured as or otherwise support a means for receiving, via each second command of the plurality of second commands, a buffer offset indicating the respective LBA range to which the second command corresponds, a size parameter indicating a total quantity of LBAs included in the respective LBA range, or a combination thereof, where writing the respective data to the physical addresses of the one or more memory devices is based at least in part on the buffer offset, the size parameter, or the combination thereof.

In some examples, the memory allocation component 555 may be configured as or otherwise support a means for releasing one or more resources of a volatile memory device of the memory system based at least in part on receiving the first command. In some examples, the L2P component 560 may be configured as or otherwise support a means for updating, using the one or more released resources and before writing the respective data to the physical addresses, L2P mapping information associated with the respective data based at least in part on the first command.

In some examples, the CLM component 585 may be configured as or otherwise support a means for disabling, in association with writing the respective data to the physical addresses, a change log manager of the memory system, L2P table management by the memory system, or both, based at least in part on updating the L2P mapping information.

In some examples, the compression component 590 may be configured as or otherwise support a means for compressing (e.g., using one or more DMA engines) one or more sequential LBA ranges of the plurality of LBA ranges, where updating the L2P mapping information is based at least in part on compressing the one or more sequential LBA ranges.

In some examples, the error correction component 565 may be configured as or otherwise support a means for disabling one or more error correction procedures associated with writing the respective data based at least in part on receiving the first command.

In some examples, to support disabling the one or more error correction procedures, the error correction component 565 may be configured as or otherwise support a means for disabling generation of error correction code data, parity data, redundancy data, or any combination thereof, in association with writing the respective data.

In some examples, to support writing the respective data to the physical addresses, the access operation component 535 may be configured as or otherwise support a means for determining a type of memory cell to which to write the respective data, one or more trim parameters associated with writing the respective data to the type of memory cell, or both, based at least in part on a quantity of the respective data, where writing the respective data to the physical addresses is in accordance with the determination.

In some examples, the read check component 570 may be configured as or otherwise support a means for refraining from performing, after writing the respective data to the physical addresses, one or more read checks on the respective data written to the physical addresses of the one or more memory devices.

In some examples, the L2P component 560 may be configured as or otherwise support a means for updating L2P mapping information associated with each of the respective data based at least in part on completing the plurality of second commands.

In some examples, the L2P component 560 may be configured as or otherwise support a means for updating, based at least in part on writing one of the respective data, L2P mapping information associated with the one of the respective data.

In some examples, the programming command sequence is associated with a programming mode of the memory system, the programming mode including a PSA programming mode or an ISP mode.

The register component 540 may be configured as or otherwise support a means for writing, to a register of a memory system operating in a programming mode, a value of a quantity of LBAs associated with writing data while operating in the programming mode. In some examples, the data reception component 530 may be configured as or otherwise support a means for receiving a plurality of commands to write the data associated with the quantity of LBAs. In some examples, the access operation component 535 may be configured as or otherwise support a means for writing the data to physical addresses of one or more memory devices of the memory system in accordance with the plurality of commands. The program mode component 545 may be configured as or otherwise support a means for exiting the programming mode based at least in part on the value and writing the data.

In some examples, the decrement component 575 may be configured as or otherwise support a means for decrementing the value based at least in part on performing a command of the plurality of commands, where exiting the programming mode is based at least in part on decrementing the value to zero.

In some examples, the LBA storage component 580 may be configured as or otherwise support a means for storing, to a volatile memory device of the memory system, LBAs associated with each command of the plurality of commands based at least in part on the memory system operating in the programming mode. In some examples, the L2P component 560 may be configured as or otherwise support a means for updating, after a completion of the plurality of commands, L2P mapping information associated with the data using the LBAs stored to the volatile memory device.

In some examples, the error correction component 565 may be configured as or otherwise support a means for disabling, based at least in part on the memory system operating in the programming mode, one or more error correction procedures associated with writing the data.

In some examples, to support disabling the one or more error correction procedures, the error correction component 565 may be configured as or otherwise support a means for disabling generation of error correction code data, parity data, redundancy data, or any combination thereof, in association with writing the data.

In some examples, to support writing the data to the physical addresses, the access operation component 535 may be configured as or otherwise support a means for determining, based at least in part on the memory system operating in the programming mode, a type of memory cell to which to write the data, one or more trim parameters associated with writing the data to the type of memory cell, or both, based at least in part on a quantity of the data, where writing the data to the physical addresses is in accordance with the determination.

In some examples, the read check component 570 may be configured as or otherwise support a means for refraining from performing, after writing the data to the physical addresses and based at least in part on the memory system operating in the programming mode, one or more read checks on the data written to the physical addresses.

In some examples, the programming mode includes a PSA programming mode or an ISP mode.

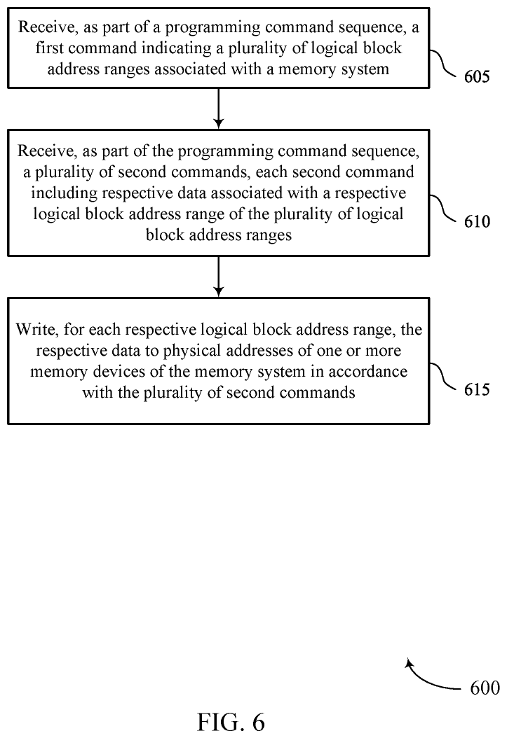

FIG. 6 illustrates a flowchart showing a method 600 that supports techniques for efficient memory system programming in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving, as part of a programming command sequence, a first command indicating a plurality of LBA ranges associated with a memory system. The operations of 605 may be performed in accordance with examples as disclosed herein. In some examples, aspects of the operations of 605 may be performed by a programming sequence component 525 as described with reference to FIG. 5.

At 610, the method may include receiving, as part of the programming command sequence, a plurality of second commands, each second command including respective data associated with a respective LBA range of the plurality of LBA ranges. The operations of 610 may be performed in accordance with examples as disclosed herein. In some examples, aspects of the operations of 610 may be performed by a data reception component 530 as described with reference to FIG. 5.

At 615, the method may include writing, for each respective LBA range, the respective data to physical addresses of one or more memory devices of the memory system in accordance with the plurality of second commands. The operations of 615 may be performed in accordance with examples as disclosed herein. In some examples, aspects of the operations of 615 may be performed by an access operation component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, as part of a programming command sequence, a first command indicating a plurality of LBA ranges associated with a memory system; receiving, as part of the programming command sequence, a plurality of second commands, each second command including respective data associated with a respective LBA range of the plurality of LBA ranges; and writing, for each respective LBA range, the respective data to physical addresses of one or more memory devices of the memory system in accordance with the plurality of second commands.

Aspect 2: The method, apparatus, or non-transitory computer-readable medium of aspect 1, where receiving the first command includes operations, features, circuitry, logic, means, or instructions, or any combination thereof for receiving an indication of a total quantity of LBA ranges of the plurality of LBA ranges, a total quantity of LBAs of the plurality of LBA ranges, a respective starting LBA for each LBA range of the plurality of LBA ranges, a respective total quantity of LBAs for each LBA range of the plurality of LBA ranges, or any combination thereof.

Aspect 3: The method, apparatus, or non-transitory computer-readable medium of any of aspects 1 through 2, further including operations, features, circuitry, logic, means, or instructions, or any combination thereof for determining whether the first command is part of the programming command sequence based at least in part on a mode parameter included in the first command, the mode parameter associated with a programming mode of the memory system.

Aspect 4: The method, apparatus, or non-transitory computer-readable medium of any of aspects 1 through 3, further including operations, features, circuitry, logic, means, or instructions, or any combination thereof for determining, for each second command of the plurality of second commands, whether the second command is part of the programming command sequence based at least in part on a mode parameter included in the second command, the mode parameter associated with a programming mode of the memory system.

Aspect 5: The method, apparatus, or non-transitory computer-readable medium of any of aspects 1 through 4, where receiving the plurality of second commands includes operations, features, circuitry, logic, means, or instructions, or any combination thereof for receiving, via each second command of the plurality of second commands, a buffer offset indicating the respective LBA range to which the second command corresponds, a size parameter indicating a total quantity of LBAs included in the respective LBA range, or a combination thereof, where writing the respective data to the physical addresses of the one or more memory devices of the memory system is based at least in part on the buffer offset, the size parameter, or the combination thereof.

Aspect 6: The method, apparatus, or non-transitory computer-readable medium of any of aspects 1 through 5, further including operations, features, circuitry, logic, means, or instructions, or any combination thereof for releasing one or more resources of a volatile memory device of the memory system based at least in part on receiving the first command and updating, using the one or more released resources and before writing the respective data to the physical addresses, L2P mapping information associated with the respective data based at least in part on the first command.

Aspect 7: The method, apparatus, or non-transitory computer-readable medium of aspect 6, further including operations, features, circuitry, logic, means, or instructions, or any combination thereof for disabling, in association with writing the respective data to the physical addresses, a change log manager of the memory system, L2P table management by the memory system, or both, based at least in part on updating the L2P mapping information.

Aspect 8: The method, apparatus, or non-transitory computer-readable medium of any of aspects 6 through 7, further including operations, features, circuitry, logic, means, or instructions, or any combination thereof for compressing one or more sequential LBA ranges of the plurality of LBA ranges, where updating the L2P mapping information is based at least in part on compressing the one or more sequential LBA ranges.

Aspect 9: The method, apparatus, or non-transitory computer-readable medium of any of aspects 1 through 8, further including operations, features, circuitry, logic, means, or instructions, or any combination thereof for disabling one or more error correction procedures associated with writing the respective data based at least in part on receiving the first command.

Aspect 10: The method, apparatus, or non-transitory computer-readable medium of aspect 9, where disabling the one or more error correction procedures includes operations, features, circuitry, logic, means, or instructions, or any combination thereof for disabling generation of error correction code data, parity data, redundancy data, or any combination thereof, in association with writing the respective data.

Aspect 11: The method, apparatus, or non-transitory computer-readable medium of any of aspects 1 through 10, where writing the respective data to the physical addresses further includes operations, features, circuitry, logic, means, or instructions, or any combination thereof for determining a type of memory cell to which to write the respective data, one or more trim parameters associated with writing the respective data to the type of memory cell, or both, based at least in part on a quantity of the respective data, where writing the respective data to the physical addresses is in accordance with the determination.

Aspect 12: The method, apparatus, or non-transitory computer-readable medium of any of aspects 1 through 11, further including operations, features, circuitry, logic, means, or instructions, or any combination thereof for refraining from performing, after writing the respective data to the physical addresses, one or more read checks on the respective data written to the physical addresses of the one or more memory devices of the memory system.

Aspect 13: The method, apparatus, or non-transitory computer-readable medium of any of aspects 1 through 5 and 9 through 12, further including operations, features, circuitry, logic, means, or instructions, or any combination thereof for updating L2P mapping information associated with each of the respective data based at least in part on completing the plurality of second commands.

Aspect 14: The method, apparatus, or non-transitory computer-readable medium of any of aspects 1 through 5 and 9 through 12, further including operations, features, circuitry, logic, means, or instructions, or any combination thereof for updating, based at least in part on writing one of the respective data, L2P mapping information associated with the one of the respective data.

Aspect 15: The method, apparatus, or non-transitory computer-readable medium of any of aspects 1 through 14, where the programming command sequence is associated with a programming mode of the memory system, the programming mode including a PSA programming mode or an ISP mode.

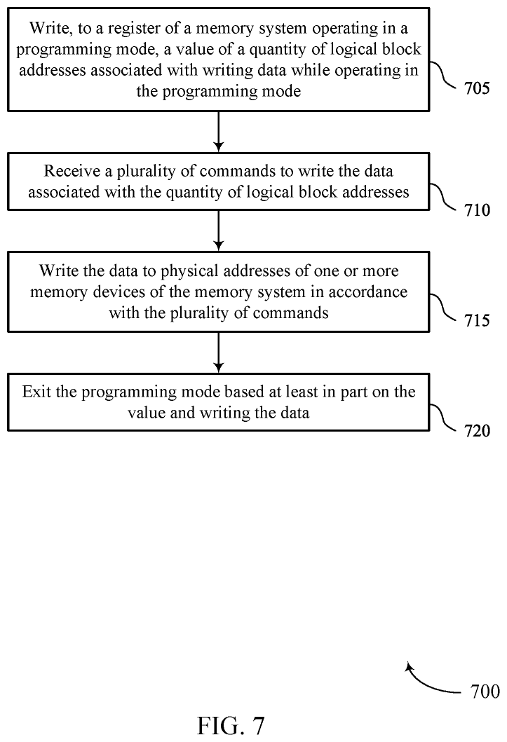

FIG. 7 illustrates a flowchart showing a method 700 that supports techniques for efficient memory system programming in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include writing, to a register of a memory system operating in a programming mode, a value of a quantity of LBAs associated with writing data while operating in the programming mode. The operations of 705 may be performed in accordance with examples as disclosed herein. In some examples, aspects of the operations of 705 may be performed by a register component 540 as described with reference to FIG. 5.

At 710, the method may include receiving a plurality of commands to write the data associated with the quantity of LBAs. The operations of 710 may be performed in accordance with examples as disclosed herein. In some examples, aspects of the operations of 710 may be performed by a data reception component 530 as described with reference to FIG. 5.

At 715, the method may include writing the data to physical addresses of one or more memory devices of the memory system in accordance with the plurality of commands. The operations of 715 may be performed in accordance with examples as disclosed herein. In some examples, aspects of the operations of 715 may be performed by an access operation component 535 as described with reference to FIG. 5.

At 720, the method may include exiting the programming mode based at least in part on the value and writing the data. The operations of 720 may be performed in accordance with examples as disclosed herein. In some examples, aspects of the operations of 720 may be performed by a program mode component 545 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 16: A method, apparatus, or non-transitory computer-readable medium including operations, features, circuitry, logic, means, or instructions, or any combination thereof for writing, to a register of a memory system operating in a programming mode, a value of a quantity of LBAs associated with writing data while operating in the programming mode; receiving a plurality of commands to write the data associated with the quantity of LBAs; writing the data to physical addresses of one or more memory devices of the memory system in accordance with the plurality of commands; and exiting the programming mode based at least in part on the value and writing the data.

Aspect 17: The method, apparatus, or non-transitory computer-readable medium of aspect 16, further including operations, features, circuitry, logic, means, or instructions, or any combination thereof for decrementing the value based at least in part on performing a command of the plurality of commands, where exiting the programming mode is based at least in part on decrementing the value to zero.

Aspect 18: The method, apparatus, or non-transitory computer-readable medium of any of aspects 16 through 17, further including operations, features, circuitry, logic, means, or instructions, or any combination thereof for storing, to a volatile memory device of the memory system, LBAs associated with each command of the plurality of commands based at least in part on the memory system operating in the programming mode and updating, after a completion of the plurality of commands, L2P mapping information associated with the data using the LBAs stored to the volatile memory device.

Aspect 19: The method, apparatus, or non-transitory computer-readable medium of any of aspects 16 through 18, further including operations, features, circuitry, logic, means, or instructions, or any combination thereof for disabling, based at least in part on the memory system operating in the programming mode, one or more error correction procedures associated with writing the data.

Aspect 20: The method, apparatus, or non-transitory computer-readable medium of aspect 19, where disabling the one or more error correction procedures includes operations, features, circuitry, logic, means, or instructions, or any combination thereof for disabling generation of error correction code data, parity data, redundancy data, or any combination thereof, in association with writing the data.

Aspect 21: The method, apparatus, or non-transitory computer-readable medium of any of aspects 16 through 20, where writing the data to the physical addresses further includes operations, features, circuitry, logic, means, or instructions, or any combination thereof for determining, based at least in part on the memory system operating in the programming mode, a type of memory cell to which to write the data, one or more trim parameters associated with writing the data to the type of memory cell, or both, based at least in part on a quantity of the data, where writing the data to the physical addresses is in accordance with the determination.

Aspect 22: The method, apparatus, or non-transitory computer-readable medium of any of aspects 16 through 21, further including operations, features, circuitry, logic, means, or instructions, or any combination thereof for refraining from performing, after writing the data to the physical addresses and based at least in part on the memory system operating in the programming mode, one or more read checks on the data written to the physical addresses.

Aspect 23: The method, apparatus, or non-transitory computer-readable medium of any of aspects 16 through 22, where the programming mode includes a PSA programming mode or an ISP mode.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memory devices; and
a controller coupled with the one or more memory devices and configured to cause the apparatus to:
receive, as part of a programming command sequence, a first command indicating a plurality of logical block address ranges associated with the apparatus;
receive, as part of the programming command sequence, a plurality of second commands, each second command comprising respective data associated with a respective logical block address range of the plurality of logical block address ranges; and
write, for each respective logical block address range, the respective data to physical addresses of the one or more memory devices in accordance with the plurality of second commands.

2. The apparatus of claim 1, wherein, to receive the first command, the controller is configured to cause the apparatus to:
receive an indication of a total quantity of logical block address ranges of the plurality of logical block address ranges, a total quantity of logical block addresses of the plurality of logical block address ranges, a respective starting logical block address for each logical block address range of the plurality of logical block address ranges, a respective total quantity of logical block addresses for each logical block address range of the plurality of logical block address ranges, or any combination thereof.

3. The apparatus of claim 1, wherein the controller is further configured to cause the apparatus to:
determine whether the first command is part of the programming command sequence based at least in part on a mode parameter included in the first command, the mode parameter of the first command associated with a programming mode of the apparatus; and
determine, for each second command of the plurality of second commands, whether each second command is part of the programming command sequence based at least in part on a mode parameter included in each second command, the mode parameter of each second command associated with the programming mode of the apparatus.

4. The apparatus of claim 1, wherein, to receive the plurality of second commands, the controller is configured to cause the apparatus to:
receive, via each second command of the plurality of second commands, a buffer offset indicating the respective logical block address range to which each second command corresponds, a size parameter indicating a total quantity of logical block addresses included in the respective logical block address range, or a combination thereof, wherein writing the respective data to the physical addresses of the one or more memory devices is based at least in part on the buffer offset, the size parameter, or the combination thereof.

5. The apparatus of claim 1, wherein the controller is further configured to cause the apparatus to:
release one or more resources of a volatile memory device of the apparatus based at least in part on receiving the first command; and
update, using the one or more released resources and before writing the respective data to the physical addresses, logical-to-physical mapping information associated with the respective data based at least in part on the first command.

6. The apparatus of claim 5, wherein the controller is further configured to cause the apparatus to:
disable, in association with writing the respective data to the physical addresses, a change log manager of the apparatus, logical-to-physical table management by the apparatus, or both, based at least in part on updating the logical-to-physical mapping information.

7. The apparatus of claim 5, wherein the controller is further configured to cause the apparatus to:
compress one or more sequential logical block address ranges of the plurality of logical block address ranges, wherein updating the logical-to-physical mapping information is based at least in part on compressing the one or more sequential logical block address ranges.

8. The apparatus of claim 1, wherein the controller is further configured to cause the apparatus to:
disable one or more error correction procedures associated with writing the respective data based at least in part on receiving the first command, the one or more error correction procedures comprising generation of error correction code data, parity data, redundancy data, or any combination thereof.

9. The apparatus of claim 1, wherein, to write the respective data to the physical addresses, the controller is further configured to cause the apparatus to:
determine a type of memory cell to which to write the respective data, one or more trim parameters associated with writing the respective data to the type of memory cell, or both, based at least in part on a quantity of the respective data, wherein writing the respective data to the physical addresses is in accordance with the determination.

10. The apparatus of claim 1, wherein the controller is further configured to cause the apparatus to:
refrain from performing, after writing the respective data to the physical addresses, one or more read checks on the respective data written to the physical addresses of the one or more memory devices.

11. The apparatus of claim 1, wherein the controller is further configured to cause the apparatus to:
update logical-to-physical mapping information associated with each of the respective data based at least in part on completing the plurality of second commands; or
update, based at least in part on writing one of the respective data, logical-to-physical mapping information associated with the one of the respective data.

12. The apparatus of claim 1, wherein the programming command sequence is associated with a programming mode of the apparatus, the programming mode comprising a pre-soldering activity programming mode or an in-system programming mode.

13. An apparatus, comprising:
one or more memory devices; and
a controller coupled with the one or more memory devices and configured to cause the apparatus to:
write, to a register of the apparatus operating in a programming mode, a value of a quantity of logical block addresses associated with writing data while operating in the programming mode;
receive a plurality of commands to write the data associated with the quantity of logical block addresses;
write the data to physical addresses of the one or more memory devices in accordance with the plurality of commands; and
exit the programming mode based at least in part on the value and writing the data.

14. The apparatus of claim 13, wherein the controller is further configured to cause the apparatus to:
decrement the value based at least in part on performing a command of the plurality of commands, wherein exiting the programming mode is based at least in part on decrementing the value to zero.

15. The apparatus of claim 13, wherein the controller is further configured to cause the apparatus to:
store, to a volatile memory device of the apparatus, logical block addresses associated with each command of the plurality of commands based at least in part on the apparatus operating in the programming mode; and
update, after a completion of the plurality of commands, logical-to-physical mapping information associated with the data using the logical block addresses stored to the volatile memory device.

16. The apparatus of claim 13, wherein the controller is further configured to cause the apparatus to:
disable, based at least in part on the apparatus operating in the programming mode, one or more error correction procedures associated with writing the data, the one or more error correction procedures comprising generation of error correction code data, parity data, redundancy data, or any combination thereof.

17. The apparatus of claim 13, wherein, to write the data to the physical addresses, the controller is further configured to cause the apparatus to:
determine, based at least in part on the apparatus operating in the programming mode, a type of memory cell to which to write the data, one or more trim parameters associated with writing the data to the type of memory cell, or both, based at least in part on a quantity of the data, wherein writing the data to the physical addresses is in accordance with the determination.

18. The apparatus of claim 13, wherein the controller is further configured to cause the apparatus to:
refrain from performing, after writing the data to the physical addresses and based at least in part on the apparatus operating in the programming mode, one or more read checks on the data written to the physical addresses.

19. The apparatus of claim 13, wherein the programming mode comprises a pre-soldering activity programming mode or an in-system programming mode.

20. A non-transitory computer-readable medium storing code comprising instructions which, when executed by a processor of an electronic device, cause the electronic device to:
receive, as part of a programming command sequence, a first command indicating a plurality of logical block address ranges associated with a memory system;
receive, as part of the programming command sequence, a plurality of second commands, each second command comprising respective data associated with a respective logical block address range of the plurality of logical block address ranges; and
write, for each respective logical block address range, the respective data to physical addresses of the memory system in accordance with the plurality of second commands.
